(19) United States
(12) Patent Application Publication
(10) Pub. No.: US 2026/0254339 A1
(43) Pub. Date: Aug. 27, 2026

(54) SWITCH CONTROLLER WITH ADAPTIVE CONTROL OF REFERENCE AND BACK-GATE VOLTAGES

(71) Applicant: TEXAS INSTRUMENTS INCORPORATED, Dallas, TX (US)

(72) Inventors: Chen FENG, Shanghai (CN); Jian LIANG, Shanghai (CN); Weiqing MA, Xian Yang (CN)

(21) Appl. No.: 19/065,252

(22) Filed: Feb. 27, 2025

(51) Int. Cl. H02M 1/00; H02M 1/088; H02M 3/157; H02M 3/158

(52) U.S. Cl. CPC H02M 1/0025; H02M 1/0022; H02M 1/088; H02M 3/157; H02M 3/158

(57) ABSTRACT

A circuit includes: a first transistor; a second transistor; and a controller. The controller has a first terminal, a second terminal, a third terminal, and a fourth terminal. The third terminal of the controller is coupled to the control terminal of the first transistor. The fourth terminal of the controller is coupled to the control terminal of the second transistor. The controller includes an error amplifier and reference voltage control circuitry configurable to: provide a first reference voltage to the error amplifier responsive to an input voltage being less than a target output voltage; and provide a second reference voltage to the error amplifier if the input voltage is greater than or equal to the target output voltage.

### BACKGROUND

Switching converters are used to provide a direct-current (DC) output voltage (VOUT) based on an input voltage (VIN). A typical switching converter includes: a power stage with switches and an inductor; and a controller for the switches of the power stage. Switch control affects switch slew rate, switch losses, and switch durability.

### SUMMARY

In an example, a circuit includes: a first transistor; a second transistor; and a controller. The first transistor has a first terminal, a second terminal, and a control terminal. The second transistor has a first terminal, a second terminal, and a control terminal. The controller has a first terminal, a second terminal, a third terminal, and a fourth terminal. The third terminal of the controller is coupled to the control terminal of the first transistor. The fourth terminal of the controller is coupled to the control terminal of the second transistor. The controller includes an error amplifier and reference voltage control circuitry. The reference voltage control circuitry is configurable to: provide a first reference voltage to the error amplifier responsive to an input voltage being less than a target output voltage; and provide a second reference voltage to the error amplifier if the input voltage is greater than or equal to the target output voltage.

In another example, a circuit includes: a switch; an error amplifier; and reference voltage control circuitry. The switch has a first terminal, a second terminal, and a control terminal. The switch is an n-channel field-effect transistor (NFET). The error amplifier has a first terminal, a second terminal, and a third terminal. The second terminal of the error amplifier is coupled to the second terminal of the switch. The reference voltage control circuitry has a first terminal, a second terminal, and a third terminal. The third terminal of the reference voltage control circuitry is coupled to the first terminal of the error amplifier.

In yet another example, a switch controller includes: an error amplifier; and reference voltage control circuitry coupled to the error amplifier. The reference voltage control circuitry is configurable to: provide a first reference voltage to the error amplifier responsive to an input voltage being less than a target output voltage; and provide a second reference voltage to the error amplifier if the input voltage is greater than or equal to the target output voltage.

### BRIEF DESCRIPTION OF THE DRAWINGS

FIGS. 1 to 4 are diagrams showing example systems.

FIG. 5 is a diagram showing example voltage reference control circuitry.

FIG. 6 is a diagram showing an example error amplifier.

FIGS. 7 and 8 are timing diagrams showing example waveforms.

FIG. 9 is a diagram showing another example system.

FIG. 10 is a schematic diagram showing example control logic for back-gate control circuitry.

FIGS. 11 to 14 are timing diagrams showing example waveforms.

### DETAILED DESCRIPTION

The same reference numbers or other reference designators are used in the drawings to designate the same or similar features. Such features may be the same or similar either by function and/or structure.

Described herein is a switch controller with adaptive control of a reference voltage (VREF) and/or a back-gate voltage (VB). In some examples, the switch controller includes a control loop and is used for control of one or more target switches of a switching converter or power stage. In some examples, the target switches of the switching converter or power stage include a high-side (HS) switch and a low-side (LS) switch. As used herein, an “HS switch” refers to a switch between a voltage supply and an output terminal, and an “LS switch” refers to a switch between the output terminal and a ground terminal. In some examples, the HS switch and the LS switch are components of a boost converter. For a boost converter: an inductor is between the voltage supply and the HS switch, where the connection between the inductor and the HS switch is referred to as a “switch node”; and the LS switch is between the switch node and a ground terminal. In some examples, the boost converter also includes a bypass switch. In such examples, the bypass switch is between the voltage supply and the output terminal (bypassing the inductor, the HS switch, and the LS switch) and may be controlled by the switch controller or another controller. The switch controller (and another controller if used) supports different modes. Example modes include a downmode, a soft-start mode, a boost mode, a pass-through mode, and a bypass mode.

As used herein, a “downmode” refers to when an output voltage (VOUT) of a boost converter is less than an input voltage (VIN). As used herein, the “soft-start mode” refers to when VOUT of a boost converter is less than VIN of the boost converter, such as during start-up, and soft-start operations are performed. During the soft-start mode, the target VOUT (VOUT_TAR) may be greater than VIN or approximately equal to VIN. If VOUT_TAR is greater than VIN, the switch controller is configurable to set or adjust VREF for the control loop to a first value such as (VREF_TAR or equivalent value). If VOUT_TAR is approximately equal to VIN, the switch controller is configurable to set or adjust VREF for the control loop to a second value such as (VIN or equivalent value) until VOUT reaches VIN or VOUT_TAR. Once VOUT reaches VIN or VOUT_TAR, the switch controller is configurable to set or adjust VREF for the control loop to the first value.

As used herein, “a boost mode” refers to a mode in which VOUT is maintained higher than VIN. The boost mode may be relevant, for example, in a battery-powered device, where VIN drops below VOUT_TAR due to ongoing use and discharge of the battery to power the battery-power device. As used herein, “a pass-through mode” refers to a mode in which VOUT is maintained approximately the same as VIN by keeping the HS switch on. As used herein, “a bypass mode” refers to a mode in which VOUT is maintained approximately the same as VIN by keeping the bypass switch on. In some examples, if the boost converter includes the bypass switch, the bypass mode is available and the pass-through mode is not used. In other examples, if the boost converter includes the bypass switch, the bypass mode and the pass-through mode are selectable. In some examples, if the boost converter does not include the bypass switch, the pass-through mode is available and the bypass mode is not used.

Besides adjusting VREF for soft-start operations (e.g., VREF has a first value when VOUT is less than VIN and has a second value once VOUT reaches VIN for pass-through mode), the switch controller is configurable to perform cycle-by-cycle regulation of the VB of a target switch. In some examples, the target switch is an N-type high-side field-effect transistor (NFET). In some examples, adaptive control of VREF and VB by the switch controller avoids pre-charge of the target switch (e.g., a high-side switch) and improves: control of inrush current and voltage ring of a boost converter when entering a pass-through mode; soft-start timing; and thermal safe operating area (SOA). In some examples, the switch controller is configured to perform switching startup operations instead of pre-charge for a high-side NFET for high-power applications. An example high-power application has a VOUT up to 3.4V and a load current up to 4 A.

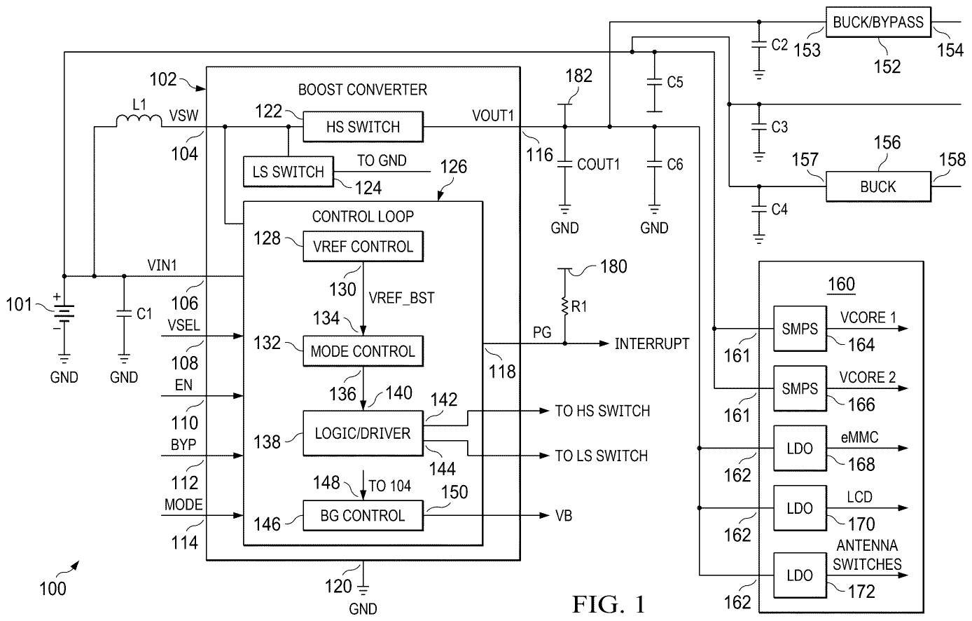

FIGS. 1 to 4 are diagrams showing example systems 100, 200, 300, and 400. As shown, the system 100 of FIG. 1 includes a direct current (DC) voltage source 101, a boost converter 102, a first voltage converter 152, a second voltage converter 156, a power management integrated circuit (PMIC) 160, power supply terminal 180, a battery terminal 182, an inductor L1, a resistor R1, and capacitors C1 to C6 and COUT1. The DC voltage source 101 has a first terminal and a second terminal. The boost converter 102 has a first terminal 104, a second terminal 106, a third terminal 108, a fourth terminal 110, a fifth terminal 112, a sixth terminal 114, a seventh terminal 116, an eighth terminal 118, and a ninth terminal 120. The first voltage converter 152 has a first terminal 153 and a second terminal 154. In some examples, the first voltage converter 152 is a buck/bypass converter. The second voltage converter 156 has a first terminal 157 and a second terminal 158. In some examples, the second voltage converter 156 is a buck converter. The PMIC 160 has first terminals 161 and second terminals 162. The inductor L1 has a first terminal and a second terminal. The resistor R1 has a first terminal and a second terminal. Each of the capacitors C1 to C6 and COUT1 has respective first terminal and a respective second terminal.

In the example of FIG. 1, the boost converter 102 includes an HS switch 122, an LS switch 124, and a control loop 126 (bypass switch omitted). The control loop 126 includes VREF control circuitry 128, mode control circuitry 132, logic/driver circuitry 138, and back-gate (BG) control circuitry 146. The HS switch 122 has a first terminal, a second terminal, a control terminal (not shown), and a back-gate terminal (not shown). The LS switch 124 has a first terminal, a second terminal, and a control terminal (not shown). The VREF control circuitry 128 has a terminal 130. The mode control circuitry 132 has a first terminal 134 and a second terminal 136. The logic/driver circuitry 138 has a first terminal 140, a second terminal 142, and a third terminal 144. The back-gate control circuitry 146 has a first terminal 148 and a second terminal 150. In some examples, the PMIC 160 includes switching mode power supplies (SMPS) 164 and 166, and low dropout regulators (LDOs) 168, 170, and 172. Each of the SMPSs 164 and 166 has a respective first terminal and a respective second terminal. Each of the LDOs 168, 170, and 172 has a respective first terminal and a respective second terminal.

In some examples, the SMPS 164 powers a first processor (not shown) using a first voltage (Vcore1). The SMPS 166 powers a second processor (not shown) using a second voltage (Vcore2). The LDO 168 powers an embedded multimedia card (eMMC) interface. The LDO 170 power a liquid crystal display (LCD). The LDO 172 powers antenna switches. In some examples, the first voltage converter 152, the capacitor C3, and the second voltage converter 156 powers amplifier/antenna terminals. In other examples, the SMPS 164, the SMPS 166, the LDO 168, the LDO 170, and the LDO 172 may be used to power other components or terminals.

In the example of FIG. 1, the first terminal of the DC voltage source 101 is coupled to the first terminals of the inductor L1, the first terminal of the capacitor C1, the second terminal 106 of the boost converter 102, the first terminal of the capacitor C3, the first terminal of the capacitor C5, and the first terminals 161 of the PMIC 160. The second terminal of the DC voltage source 101 is coupled to ground or a ground terminal. The second terminal of the inductor L1 is coupled to the first terminal 104 of the boost converter 102. The second terminal of the capacitor C1 is coupled to ground or a ground terminal. The seventh terminal 116 of the boost converter 102 is coupled to the battery terminal 182, the first terminal of the capacitor COUT, the first terminal of the capacitor C6 and the second terminals 162 of the PMIC 160. The first terminal of the resistor R1 is coupled to the power supply terminal 180. The second terminal of the resistor R1 is coupled to the eighth terminal 118 of the boost converter 102. The ninth terminal 120 of the boost converter 102 is coupled to ground or a ground terminal.

The first terminal of the HS switch 122 and the first terminal of the LS switch 124 are coupled to the first terminal 104 of the boost converter 102. The first terminal 104, the second terminal 106, the third terminal 108, the fourth terminal 110, the fifth terminal 112, and the sixth terminal 114 are coupled to the control loop 126. The second terminal of the HS switch 122 is coupled to the seventh terminal 116 of the boost converter 102. The second terminal of the LS switch 124 is coupled to ground or a ground terminal.

The terminal 130 of the VREF control circuitry 128 is coupled to the first terminal 134 of the mode controller circuitry 132. The second terminal 136 of the mode control circuitry 132 is coupled to the first terminal 140 of the logic/driver circuitry 138. The second terminal 142 of the logic/driver circuitry 138 is coupled to the control terminal (not shown) of the HS switch 122. The third terminal 144 of the logic/driver circuitry 138 is coupled to the control terminal (not shown) of the LS switch 124. The first terminal 148 of the back-gate control circuitry 146 is coupled to the first terminal 104 of the boost converter 102. The second terminal of back-gate control circuitry 146 is coupled to the back-gate terminal (not shown) of the HS switch 122.

In the example of FIG. 1, the first terminal 153 of the first voltage converter 152 is coupled to the seventh terminal 116 of the boost converter 102 and receives VOUT1. The first terminal 157 of the second volage converter 156 is coupled to the first terminal of the DC voltage source 101 and receives VIN1. In some examples, the second terminal 154 of the first voltage converter 152 and the second terminal 158 of the second voltage converter 156 are coupled to and power respective amplifier/antenna modules (not shown).

In some examples, the boost converter 102 is configurable to: receive a switch node voltage (VSW) at the first terminal 104; receive an input voltage (VIN1) at the second terminal 106; receive a first control signal (VSEL) at the third terminal 108; receive an enable signal (EN) at the fourth terminal 110; receive a bypass control signal (BYP) at the fifth terminal 112; receive a mode control signal (MODE) at the sixth terminal 114; provide VOUT1 at the seventh terminal 116 responsive to the SW voltage, VIN1, VSEL, EN, BYP, MODE, the operations of the control loop 126, the operations of the HS switch 122, and the operations of the LS switch 124; and provide an interrupt signal at the eighth terminal 118 responsive to VOUT reaching a target threshold or range (i.e., power is ready).

In some examples, the control loop 126 of the boost converter 102 is configurable to change VREF when entering a pass-through mode from VIN1 to VOUT_TAR. In some examples, the control loop 126 of the boost converter 102 is configurable to perform cycle-by-cycle regulation of the back-gate voltage of the HS switch 122 using the back-gate control circuitry 146. In some examples, the HS switch 122 is an NFET. In some examples, the control loop 126 of the boost converter 102 performs linear soft start for both downmode and boost mode intervals. Adaptive control of reference and back-gate voltages by the control loop 126 avoids pre-charge of the HS switch 122 and improves: control of inrush current and voltage ring of the boost converter 102 when entering the pass-through mode; soft-start timing; and thermal SOA. In some examples, the control loop 126 is configurable to perform switching startup operations instead of pre-charge for HS switch 122 for high-power applications.

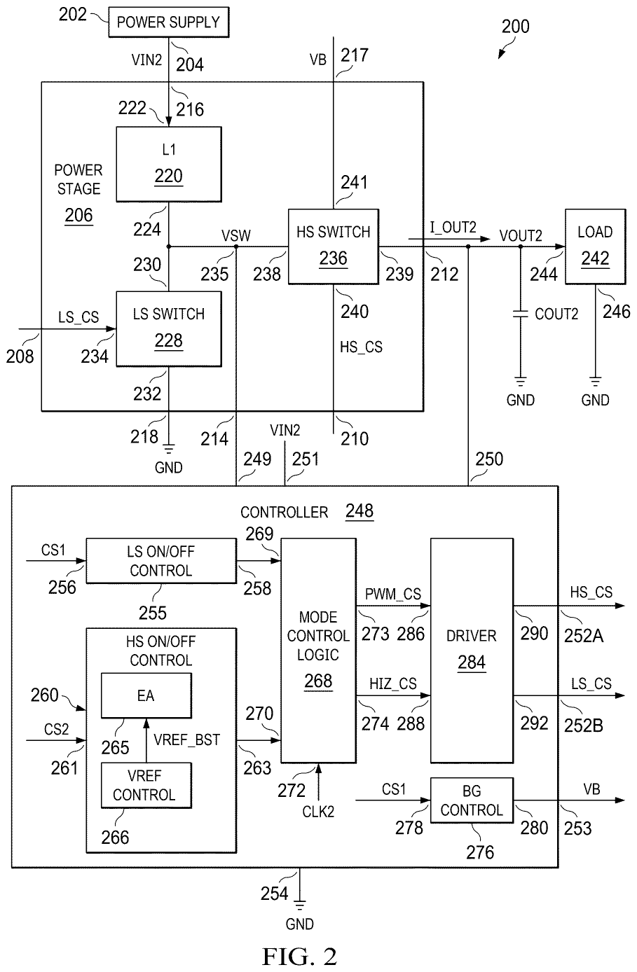

The system 200 of FIG. 2 includes a power supply 202, a power stage 206, a capacitor COUT2, a load 242, and a controller 248. The power supply 202 has a terminal 204. The power stage 206 has a first terminal 208, a second terminal 210, a third terminal 212, a fourth terminal 214, a fifth terminal 216, a sixth terminal 217, and a seventh terminal 218. The output capacitor COUT2 has a first terminal and a second terminal. The load 242 has a first terminal 244 and a second terminal 246. The controller 248 has a first terminal 249, a second terminal 250, a third terminal 251, a fourth terminal 252A, a fifth terminal 252B, a sixth terminal 253, and a seventh terminal 254.

As shown, the power stage 206 includes an inductor (e.g., L1) 220, an LS switch 228, and an HS switch 236 in the arrangement shown. In some examples, the LS switch 228, the HS switch 236, and related control circuitry are components of an IC, while the inductor 220 is an external component relative to the IC. The arrangement of components for the power stage 206 of FIG. 2 is referred to as a boost converter topology, where the output voltage (VOUT2) is the same or is higher than the input voltage (VIN2). In other examples, a power stage may have a buck-boost converter topology. In the example of FIG. 2, the first switch 228 has a first terminal 230, a second terminal 232, and a control terminal 234. The HS switch 236 has a first terminal 238, a second terminal 239, a control terminal 240, and a back-gate terminal 241. In some examples, the LS switch 228 and/or the HS switch 236 may be NFETs. The inductor 220 has a first terminal 222 and a second terminal 224.

The controller 248 includes LS on/off control circuitry 255, HS on/off control circuitry 260, mode control logic 268, and driver circuitry 284. The LS on/off control circuitry 255 has first terminal(s) 256 and a second terminal 258. The HS on/off control circuitry 260 has first terminal(s) 261 and a second terminal 263. In the example of FIG. 2, the HS on/off control circuitry 260 includes an error amplifier (EA) 265 and VREF control circuitry 266. The mode control logic 268 has a first terminal 269, a second terminal 270, a third terminal 272, a fourth terminal 273, and a fifth terminal 274. The driver circuitry 284 has a first terminal 286, a second terminal 288, a third terminal 290, and a fourth terminal 292. In the example of FIG. 2, the mode control logic 268 and the driver circuitry 284 is an example of the logic/driver circuitry 138 in FIG. 1. The back-gate control circuitry 276 has a first terminal 278 and a second terminal 280. The back-gate control circuitry 276 is an example of the back-gate control circuitry 146 of FIG. 1.

The first terminal 208 of the power stage 206 is coupled to the fifth terminal 252B of the controller 248. The second terminal 210 of the power stage 206 is coupled to the fourth terminal 252A of the controller 248. The third terminal 212 of the power stage 206 is coupled to the first terminal of the output capacitor COUT2, the first terminal 244 of the load 242, and the second terminal 250 of the controller 248. The second terminal of the output capacitor COUT2 is coupled to ground or a ground terminal. The second terminal 246 of the load 242 is coupled to ground or a ground terminal. The fourth terminal 214 of the power stage 206 is coupled to the first terminal 249 of the controller 248. The fifth terminal 216 of the power stage 206 is coupled to the terminal 204 of the power supply 202. The terminal 204 of the power supply 202 is also coupled to the third terminal 251 of the controller 248. The seventh terminal 218 of the power stage 206 is coupled to ground or a ground terminal. The seventh terminal 254 of the controller 248 is also coupled to ground or a ground terminal.

As shown, the first terminal 222 of the inductor 220 is coupled to the fifth terminal 216 of the power stage 206. The second terminal 224 of the inductor 220 is coupled to the first terminal 230 of the LS switch 228 and to the first terminal 238 of the HS switch 236. The second terminal 232 of the LS switch 228 is coupled to the seventh terminal 218 of the power stage 206. The control terminal 234 of the LS switch 228 is coupled to the first terminal 208 of the power stage 206. The second terminal 239 of the HS switch 236 is coupled to the third terminal 212 of the power stage 206. The control terminal 240 of the HS switch 236 is coupled to the second terminal 210 of the power stage 206. The back-gate terminal 241 is coupled to the sixth terminal 217 of the power stage 206. As shown, the fourth terminal 214 of the power stage is coupled to a switch node 235 between the LS switch 228 and the HS switch 236.

As shown, the first terminal(s) 256 of the LS on/off control circuitry 255 receive control signal(s) CS1. In some examples, CS1 includes a LS switch on signal (e.g., LS_ON herein). The first terminal(s) 261 of the HS on/off control circuitry 260 receive control signal(s) CS2. In some examples, CS2 includes VOUT2 or a scaled version of VOUT2, and an HS SWITCH on signal (e.g., HS_ON herein). The LS on/off control circuitry 255 and/or the HS on/off control circuitry 260 are part of a control loop (e.g., part of the mode control circuitry 132 of the control loop 126 in FIG. 1). In some examples, the VREF control circuitry 266 is configurable to adjust VREF (VREF_BST) provided to the error amplifier 265 when entering a pass-through mode of the power stage 206 (e.g., VREF is adjusted from VIN1 to VOUT_TAR once VOUT1 reaches VIN1 and the pass-through begins).

The first terminal 269 of the mode control logic 268 is coupled to the second terminal 258 of the LS on/off control circuitry 255. The second terminal 270 of the mode control logic 268 is coupled to the second terminal 263 of the HS on/off control circuitry 260. The third terminal 272 of the mode control logic 268 receives a clock signal (CLK2). The fourth terminal 273 of the mode control logic 268 is coupled to the first terminal 286 of the driver circuitry 284. The fifth terminal 274 of the mode control logic 268 is coupled to the second terminal 288 of the driver circuitry 284. The third terminal 290 of the driver circuitry 284 is coupled to the fourth terminal 252A of the controller 248. The fourth terminal 292 of the driver circuitry 284 is coupled to the fifth terminal 252B of the controller 248.

In operation, the controller 248 is configurable to: receive VIN2 at its third terminal 251; receive VSW at its first terminal 249; receive VOUT2 at its second terminal 250; provide HS_CS at its fourth terminal 252A responsive to VIN2, VSW, VOUT2, and the operations of the HS on/off control circuitry 260, the mode control logic 268, and the driver circuitry 284; provide LS_CS at its fifth terminal 252B responsive to VIN2, VSW, VOUT2, and the operations of the LS on/off control circuitry 255, the mode control logic 268, and the driver circuitry 284. In some examples, modes supported by the controller 248 include a pulse-width modulation (PWM) mode and a pulse-frequency modulation (PFM) mode.

The mode control logic 268 is configurable to: receive LS on/off results from the LS on/off control circuitry 255 at the first terminal 269; receive HS on/off results from the HS on/off control circuitry 260 at the second terminal 270; receive a clock signal (CLK2) at the third terminal 272; provide a PWM control signal (PWM_CS) at the fourth terminal 273 responsive to the LS on/off results and/or the HS on/off results; and provide a high-impedance control signal (HIZ_CS) at the fifth terminal 274 responsive to the LS on/off results and/or the HS on/off results.

In the example of FIG. 2, the driver circuitry 284 is configurable to: receive PWM_CS at the first terminal 286; receive HIZ_CS at the second terminal 288; provide a first control signal (HS_CS) at the third terminal 290 responsive to PWM_CS and/or HIZ_CS; and provide a second control signal (LS_CS) at the fourth terminal 292 responsive to PWM_CS and/or HIZ_CS. In some examples, the back-gate control circuitry 276 is configurable to perform cycle-by-cycle regulation (every switching cycle) of VB provided to the back-gate terminal 241 of the HS switch 236. With adaptive control of VREF_BST and VB, the controller 248 avoids pre-charge of the HS switch 236 and improves: control of inrush current and voltage ring of the power stage 206 when entering a pass-through mode; soft-start timing; and thermal SOA.

In operation, the power stage 206 is configurable to: receive VIN2 at its fifth terminal 216; receive HS_CS at its first terminal 208; receive LS_CS at its second terminal 210; provide VOUT2 at its third terminal 212 responsive to VIN2, HS_CS, and LS_CS; and provide V_{SW2} at its fourth terminal 214 responsive to VIN2, HS_CS, and LS_CS. More specifically, when the LS switch 228 is on and the HS switch 236 is off, current in the inductor 220 increases. When the LS switch 228 is off and the HS switch 236 is on, current in the inductor 220 decreases. The average current in the inductor 220 is considered the load current (I_out2) provided to the load 242.

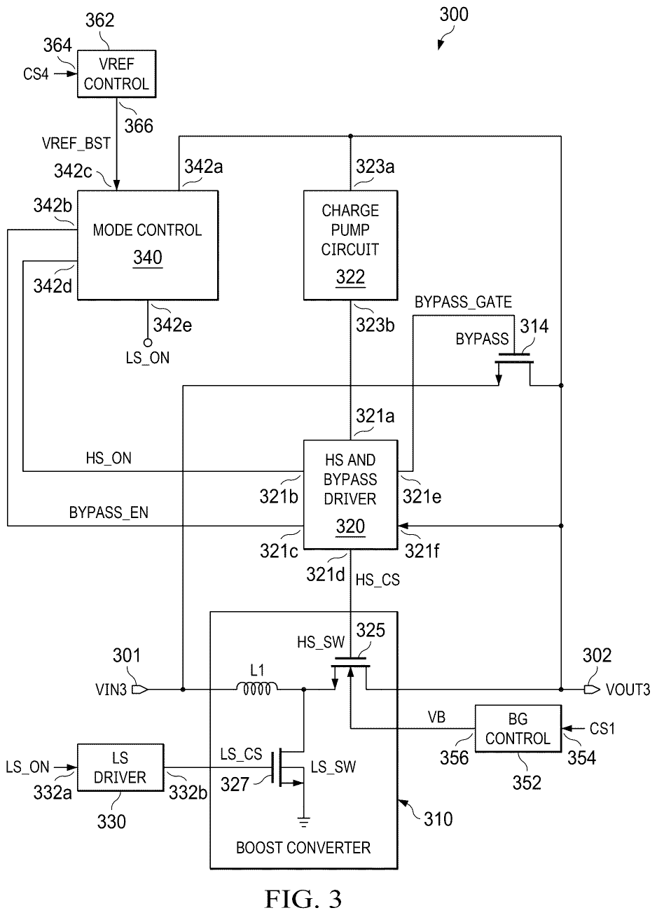

The system 300 of FIG. 3 includes a boost converter 310, a bypass switch or transistor 314, a high-side and bypass driver circuitry 320, charge pump circuitry 322, low-side driver circuitry 330, mode control circuitry 340, back-gate control circuitry 352, and VREF control circuitry 362. The system 300 also includes an input terminal 301 and an output terminal 302. An input voltage (VIN3), from a battery or other type of power source, is provided to the input terminal 301. The system 300 generates an output voltage (VOUT3) at the output terminal 302. The boost converter 310 includes an HS transistor (sometimes HS switch herein) 325, an LS transistor (sometimes LS switch herein) 327, and the inductor L1. The boost converter 310 is an example of the boost converter 102 in FIG. 1, or the power stage 206 in FIG. 2. The high-side and bypass driver circuitry 320 is part of the logic/driver circuitry 138 in FIG. 1, or part of the driver circuitry 284 in FIG. 2. The low-side driver circuitry 330 is part of the logic/driver circuitry 138 in FIG. 1, or part of the driver circuitry 284 in FIG. 2. The mode control circuitry 340 is an example of the mode control circuitry 132 in FIG. 1, or the mode control logic 268 in FIG. 2. The back-gate control circuitry 352 is an example of the back-gate control circuitry 146 in FIG. 1, or the back-gate control circuitry 276 in FIG. 2. The VREF control circuitry 362 is an example of the VREF control circuitry 128 in FIG. 1, or the VREF control circuitry 266 in FIG. 2. In some examples, the components of FIG. 3 may all be fabricated on the same integrated circuit (IC). In other examples, all of the components except the inductor L1 are fabricated on the same IC, and the inductor L1 is an external component with respect to the IC.

In the example of FIG. 3, each of the bypass transistor 314, the HS transistor 325 and the LS transistor 327 is an NFET with a respective first terminal, a respective second terminal, and a respective control terminal. The bypass transistor 314 has a first terminal, a second terminal, and a control terminal. The high-side and bypass driver circuitry 320 has a first terminal 321a, a second terminal 321b, a third terminal 321c, a fourth terminal 321d, a fifth terminal 321e, and a sixth terminal 321f. The charge pump circuitry 322 has a first terminal 323a and a second terminal 323b. The low-side driver circuitry 330 has a first terminal 332a and a second terminal 332b. The mode control circuitry 340 has a first terminal 442a, a second terminal 442b, a third terminal 442c, a fourth terminal 442d, and a fifth terminal 442e. The back-gate control circuitry 352 has a first terminal 354 and a second terminal 356. The VREF control circuitry 362 has a first terminal 364 and a second terminal 366.

In the example of FIG. 3, a first terminal of inductor L1 is coupled to the input terminal 301. The second terminal of the inductor L1 is coupled to the first terminal of the HS transistor 325 and to the first terminal of the LS transistor 327. The second terminal of the LS transistor 327 is coupled to ground or a ground terminal. The second terminal of the HS transistor 325 is coupled to the output terminal 302. The first terminal of the bypass transistor 314 is coupled to the input terminal 301, and the second terminal of the bypass transistor 314 is coupled to the output terminal 302. When the bypass transistor 314 is turned on, current from the input terminal 301 flows through bypass transistor 314 to the output terminal 302 thereby bypassing the boost converter 310.

In the example of FIG. 3, the first terminal 342a and the third terminal 342c are input terminals of the mode control circuitry 340. The second terminal 342b, and the fourth terminal 342d are output terminals of the mode control circuitry 340. In operation, the mode control circuitry 340 generates a bypass enable signal BYPASS_EN at the second terminal 342b, a high-side control signal HS_ON at the fourth terminal 342d, and low-side control signal LS_ON at fourth terminal 342e. In the example of FIG. 3, the first terminal 321a, the second terminal 321b, the third terminal 321c, and the sixth terminal 321f are input terminals of the HS and bypass driver circuitry 320. The fourth terminal 321d and the fifth terminal 321e are output terminals of the HS and bypass driver circuitry 320. The first terminal 323a is an input terminal of the charge pump circuitry 322. The second terminal 323b is an output terminal of the charge pump circuitry 322.

In the example of FIG. 3, the first terminal 323a of the charge pump circuitry 322 and the first terminal 342a of the mode control circuitry 340 are coupled to the output terminal 302. In some examples, the charge pump circuitry 322 performs charge pump operations based on VOUT3, which may be, in one example, 5V larger than VIN3. In some examples, the second terminal 323b of charge pump circuitry 322 has a voltage equal to VOUT+5V. The second terminal 342b of the mode control circuitry 340 is coupled to the third terminal 321c of the HS and bypass driver circuitry 320. The fourth terminal 342d of the mode control circuitry 340 is coupled to the second terminal 321b of the HS and bypass driver circuitry 320. In the example of FIG. 3, the fifth terminal 342e of the mode control circuitry 340 is coupled to the first terminal 332a of the low-side driver circuitry 330. The second terminal 332b of low-side driver circuitry 330 is coupled to the control terminal of the LS transistor 327. In some examples, the fourth terminal 321d and the fifth terminal 321e of HS and bypass driver circuitry 320 are coupled to the control terminals of HS transistor 325 and the bypass transistor 314, respectively. The second terminal 323b of charge pump circuitry 322 is coupled to first terminal 321a of the HS and bypass driver circuitry 320. The output terminal 302 of the system 300 is coupled to the sixth terminal 321f of HS and bypass driver circuitry 320 and provides power to the HS and bypass driver circuitry 320.

When the bypass transistor 314 is turned on, VOUT3 is approximately equal to the VIN3. The mode control circuitry 340 determines whether VOUT3 is above or below a threshold. In response to determining that the VOUT3 is above the threshold, the mode control circuitry 340 asserts signals BYPASS_EN, HS_ON, and LS_ON to logic levels that direct the HS and bypass driver circuitry 320 to maintain the bypass transistor 314 on and the HS transistor 325 off and direct the low-side driver circuitry 330 to maintain LS transistor 327 off. Accordingly, when VOUT3 is above the threshold, the boost converter 310 is turned off and bypass transistor 314 is turned on. In response to determining that VOUT3 is below the threshold, mode control circuitry 340 asserts signal BYPASS to a logic level, resulting in the HS and bypass driver circuitry 320 turning the bypass transistor 314 off. Further, the mode control circuitry 340 alternately toggles signals HS_ON and LS_ON to the respective control terminals of the HS transistor 325 and the LS transistor 327 to enable operation of the boost converter 310.

In some examples, the pass-through mode is not used with the system 300 due to availability of the bypass transistor 314 and related bypass mode operations. In other examples, a pass-through mode may be used instead of the bypass mode even with availability of the bypass transistor 314. In such examples, the VREF control circuitry 362 is configurable to adjust VREF (sometimes referred to as VREF_BST herein) provided to the mode control circuitry 340 when entering the pass-through mode. During boost mode operations, the back-gate control circuitry 352 is configurable to perform cycle-by-cycle regulation (every switching cycle) of VB provided to the back-gate terminal of the HS transistor 325. During pass-through mode operations, the back-gate control circuitry 352 is configurable to provide VB to the back-gate terminal of the HS transistor 325 for HS switch on operations. With adaptive control of VREF_BST and VB, pre-charge of the HS transistor 325 is avoided and improves: control of inrush current and voltage ring of the boost converter 310 when entering a pass-through mode; soft-start timing; and thermal SOA.

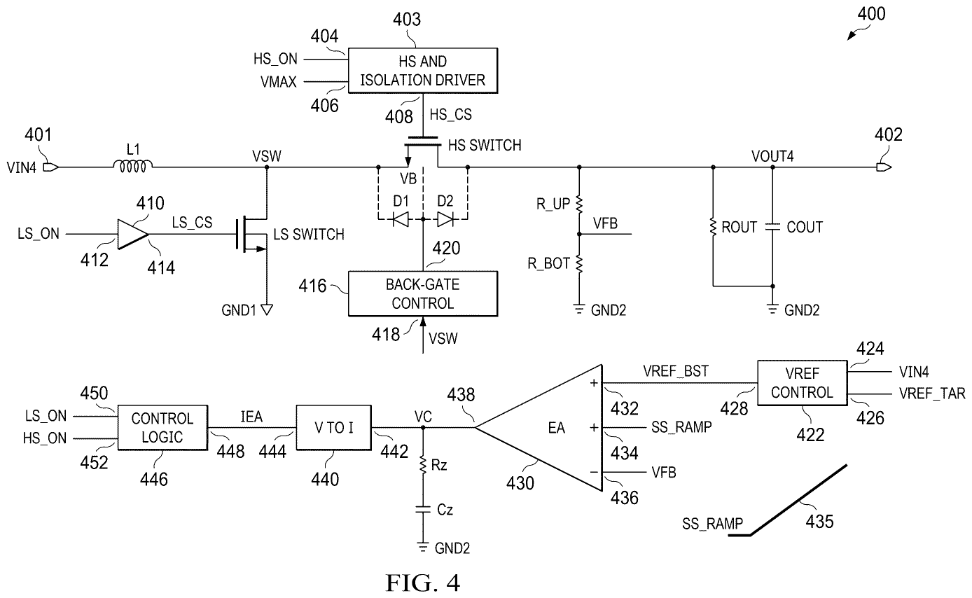

The system 400 of FIG. 4 includes an input terminal 401, an output terminal 402, HS and isolation driver circuitry 403, the inductor L1, LS switch, HS switch, LS driver circuitry 410, diodes D1 and D2, back-gate control circuitry 416, capacitor COUT, and resistors R_UP, R_BOT, and ROUT. The system 400 also includes VREF control circuitry 422, an error amplifier 430, resistor Rz, capacitor Cz, a voltage-to-current converter 440, and control logic 446. In the example of FIG. 4, the bypass switch or transistor and related bypass operations are omitted. In other examples, a bypass switch or transistor is included between the input terminal 401 and the output terminal 402. In some examples, the HS and isolation driver circuitry 403 is part of the control loop 126 in FIG. 1, part of the HS on/off control circuitry 260 in FIG. 2, part of the HS and bypass driver circuitry 320 in FIG. 3. The LS driver circuitry 410 is part of the control loop 126 in FIG. 1, part of the LS on/off control circuitry 255 in FIG. 2, or the low-side driver circuitry 330 in FIG. 3. The back-gate control circuitry 416 is an example of the back-gate control circuitry 146 in FIG. 1, the back-gate control circuitry 276 in FIG. 2, or the back-gate control circuitry 352 in FIG. 3. The VREF control circuitry 422 is an example of the VREF control circuitry 128 in FIG. 1, the VREF control circuitry 266 in FIG. 2, or the VREF control circuitry 362 in FIG. 3. In some examples, the error amplifier 430 is part of the mode control circuitry 132 in FIG. 1, the error amplifier 265 in FIG. 2, or part of the mode control circuitry 340 in FIG. 3. In some examples, the resistors R_UP, R_BOT, the error amplifier 265, the resistor Rz, the capacitor Cz, and the voltage-to-current converter 440 are components of the control loop 126 in FIG. 1, the HS on/off control circuitry 260 and the mode control logic 268 in FIG. 2, or the mode control circuitry 340 in FIG. 3. In some examples, the control logic 446 is part of logic/driver circuitry 138 in FIG. 1, the mode control logic 268 in FIG. 2, or the mode control circuitry 340 in FIG. 3.

In the example of FIG. 4, the HS and isolation driver circuitry 403 has a first terminal 404, a second terminal 406, and a third terminal 408. The back-gate control circuitry 416 has a first terminal 418 and the second terminal 420. The LS driver circuitry 410 has a first terminal 412 and a second terminal 414. The VREF control circuitry 422 has a first terminal 424, a second terminal 426, and a third terminal 428. The error amplifier 430 has a first terminal 432, a second terminal 434, a third terminal 436, and a fourth terminal 438. The voltage-to-current converter 440 has a first terminal 442 and a second terminal 444. The control logic 446 has a first terminal 448, a second terminal 450, and a third terminal 452. The LS switch has a first terminal, a second terminal, and a control terminal. The HS switch has a first terminal, a second terminal, and a control terminal. Each of the inductor L1, the diode D1, the diode D2, the resistor R_UP, the resistor R_BOT, the resistor ROUT, the capacitor COUT, the resistor Rz, and the capacitor Cz has a respective first terminal and a respective second terminal. The first terminals of the diodes D1 and D2 are anode terminal, and the second terminals of the diodes D1 and D2 are cathode terminals.

The input terminal 401 is coupled to the first terminal of the inductor L1. The second terminal of the inductor L1 is coupled to the first terminal of the of the LS switch, the first terminal of the HS switch, the second terminal of the diode D1, and the first terminal 418 of the back-gate control circuitry 416. The second terminal of the LS switch is coupled to ground or a ground terminal. The second terminal of the HS switch is coupled to the second terminal of the diode D2, the first terminal of the resistor R_UP, the first terminal of the resistor ROUT, the first terminal of the capacitor COUT, and the output terminal 402. The first terminals of the diodes D1 and D2 are coupled to the second terminal 420 of the back-gate control circuitry 416. The second terminal of the resistor R_UP is coupled to the first terminal of the resistor R_BOT and the third terminal 436 of the error amplifier 430. The second terminal of the resistor R_BOT is coupled to ground or a ground terminal. The second terminals of the resistor ROUT and the capacitor COUT are coupled to ground or a ground terminal. The first terminal 424 of the VREF control circuitry 422 is coupled to the input terminal 401.

In some examples, the second terminal 426 of the VREF control circuitry 422 receives a target VREF from a fixed or programmable voltage source (not shown). The third terminal 428 of the VREF control circuitry 422 is coupled to the first terminal 432 of the error amplifier 430. The second terminal 434 of the error amplifier 430 receives a soft-start (SS) ramp voltage (SS_RAMP) 435 from a ramp voltage source (not shown). The third terminal 436 of the error amplifier 430 receives a feedback voltage (VFB), which is a scaled version of VOUT4 based on the relative values of R_UP and R_BOT. The fourth terminal 438 of the error amplifier 430 provide a control volage (VC) and is coupled to the first terminal of the resistor Rz and the first terminal 442 of the voltage-to-current converter 440. The second terminal of the resistor Rz is coupled to the first terminal of the capacitor Cz. The second terminal of the capacitor Cz is coupled to ground or a ground terminal. The second terminal 444 of the voltage-to-current converter 440 is coupled to the first terminal 448 of the control logic 446. The second terminal 450 of the control logic 446 is coupled to the first terminal 412 of the LS driver circuitry 410. The second terminal 414 of the LS driver circuitry 410 is coupled to the control terminal of the LS switch. The third terminal 452 of the control logic 446 is coupled to the first terminal 404 of the HS and isolation driver circuitry 403. The second terminal 406 of the HS and isolation driver circuitry 403 receive a max voltage (VMAX) from a VMAX source (not shown). The third terminal 408 of the HS and isolation driver circuitry 403 is coupled to the control terminal of the HS switch. HS driver and isolation driver circuitry 403 provides HS_CS to the control terminal of the HS SWITCH in boost mode (VIN<VOUT) and in downmode (VIN>VOUT).

In operation, the on trigger for the HS switch is controlled by a control loop that includes the VREF control circuitry 422, the error amplifier 430, the voltage-to-current converter 440, and the control logic 446. The on-time for the HS switch is controlled by other components (not shown). In some examples, the on-time for the HS switch may be controlled based on peak current detection and/or an on-time timer. in some examples, a pass-through mode starts responsive to VIN4 being higher than VOUT 4 and VOUT4 reaching a target value. The pass-through mode ends responsive to VOUT4 being lower than a target value by a threshold amount (VOUT target—50 mV). In the pass-through mode, the VOUT4 at the output terminal 402 is approximately equal to VIN4 at the input terminal 401. In a boost mode, VOUT4 at the output terminal 402 is greater than VIN4 at the input terminal 401.

In the example of FIG. 4, the VREF control circuitry 422 is configurable to adjust VREF_BST responsive to VREF_TAR and VIN4. If VOUT_TAR is approximately equal to VIN4, the VREF control circuitry 422 is configurable to set or adjust VREF_BST for the control loop to a second value (VIN4 or equivalent value) until VOUT reaches VIN4 or VOUT_TAR. Once VOUT reaches VIN4 or VOUT_TAR, the VREF control circuitry 422 is configurable to set or adjust VREF_BST for the control loop to a first value (e.g., VOUT_TAR). The VREF control circuitry 422 provides the first value for VREF_BST upon entering a pass-through mode. In some examples, back-gate control circuitry 416 performs cycle-by-cycle regulation of VB provided to the back-gate terminal of the HS switch. In some examples, during a downmode (VIN4 greater than VOUT4) with the LS switch on, the back-gate control circuitry 416 provides VB=0 to the back-gate of the HS switch. In some examples, during a downmode with the HS switch on, the back-gate control circuitry 416 provides VB=VOUT4 to the back-gate terminal of the HS switch. In some examples, during a boost mode (VOUT4 greater than VIN4) with the LS switch on, the back-gate control circuitry 416 provides VB=VSW (VSW=0 when the LS switch is on) to the back-gate terminal of the HS switch. In some examples, during a boost mode (VOUT4 greater than VIN4) with the HS switch on, the back-gate control circuitry 416 provides VB=VSW (VSW=VOUT when the HS switch is on) to the back-gate terminal of the HS switch.

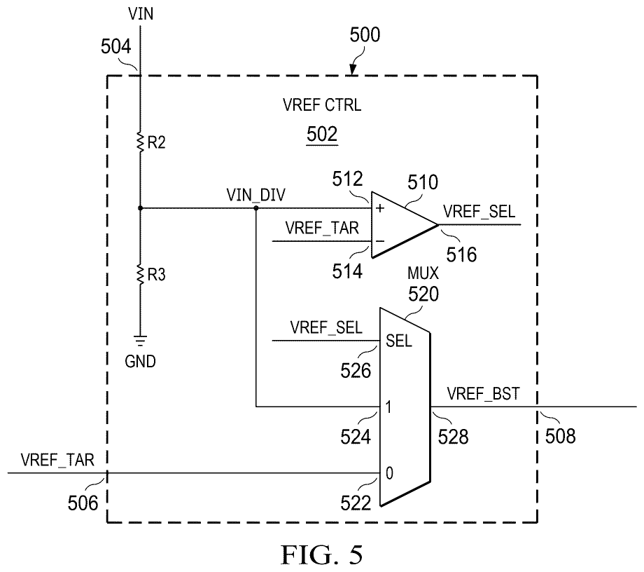

FIG. 5 is a diagram showing example VREF control circuitry 500. The VREF control circuitry 500 is an example of the VREF control circuitry 128 in FIG. 1, the VREF control circuitry 266 in FIG. 2, the VREF control circuitry 362 in FIG. 3, or the VREF control circuitry 422 in FIG. 4. In the example of FIG. 5, the VREF control circuitry 500 has a first terminal 504, a second terminal 506, and a third terminal 508. The VREF control circuitry 500 includes resistors R2 and R3, comparator 510, and a multiplexer 520. Each of the resistors R2 and R3 has a respective first terminal and a respective second terminal. The comparator 510 has a first terminal 512, a second terminal 514, and a third terminal 516. The multiplexer 520 has a first terminal 522, a second terminal 524, a third terminal 526, and a fourth terminal 528.

The first terminal 502 of the VREF control circuitry 500 receives VIN and is coupled to the first terminal of the resistor R2. The second terminal of the resistor R2 is coupled to the first terminal of the of the resistor R3, the first terminal 512 of the comparator 510, and the second terminal 524 of the multiplexer 520. The second terminal of the resistor R3 is coupled to ground or a ground terminal. The second terminal 506 of the VREF control circuitry 500 is coupled to the second terminal 514 of the comparator 510. The third terminal 516 of the comparator 510 is coupled to the third terminal 526 of the multiplexer 520. The fourth terminal 528 of the multiplexer 520 is coupled to the third terminal of the VREF control circuitry 500.

In some examples, the VREF control circuitry 500 operates to: receive VIN at the first terminal 504; receive VREF_TAR at the second terminal 506; and provide VREF_BST at the third terminal responsive to VIN and VREF_TAR. The resistors R2 and R3 provide a scaled version (VIN_DIV) of VIN. The comparator 510 operates to: receive VIN_DIV at the first terminal 512; receive VREF_TAR at the second terminal 514; and provide a compare result VREF_SEL responsive to VIN_DIV and VREF_TAR. If VREF_TAR is greater than to equal to VIN_DIV, VREF_SEL is a logical “0”. If VREF_TAR is less than VIN_DIV, VREF_SEL is a logical “1”. The multiplexer 520 operates to: receive VREF_TAR at the first terminal 522; receive VIN_DIV at the second terminal 524; receive VREF_SEL at the third terminal 526; provide VREF_BST=VREF_TAR when VREF_SEL is a logical “0”; and provide VREF_BST=VIN_DIV when VREF_SEL is a logical “1”.

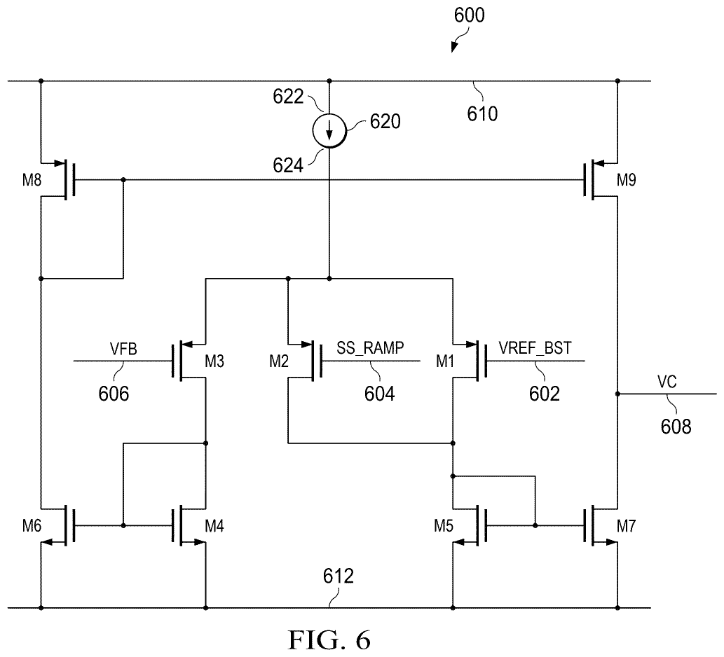

FIG. 6 is a diagram showing an example error amplifier 600. The error amplifier 600 is an example of the error amplifier 265 in FIG. 2, or the error amplifier 430 in FIG. 4. The error amplifier 600 has a first terminal 602, a second terminal 604, a third terminal 606, a fourth terminal 608, a fifth terminal 610, and a sixth terminal 612. In the example of FIG. 6, the error amplifier 600 includes a current source 620 and transistors M1 to M9. The transistors M1, M2, M3, M8, and M9 are P-channel field-effect transistors (PFETs). The transistors M4 to M7 are NFETs. The current source 620 has a first terminal 622 and a second terminal 624. Each of the transistors M1 to M9 has a respective first terminal, a respective second terminal, and a respective control terminal.

In the example of FIG. 6, the fifth terminal 610 of the error amplifier is coupled to the first terminal 622 of the current source 620 and the first terminals of the transistors M8 and M9. The second terminal of the transistor M8 is coupled to the control terminals of the transistors M8 and M9, the first terminals of the transistors M6. The second terminal 624 of the current source 620 is coupled to the first terminals of the transistors M1 to M3. The second terminal of the transistor M3 is coupled to the first terminal of the transistor M4 and the control terminals of the transistors M4 and M6. The second terminals of the transistors M1 and M2 are coupled to the first terminal of the transistor M5 and the control terminals of the transistors M5 and M7. The second terminals of the transistors M4 to M7 are coupled to the sixth terminal 612 of the error amplifier 600. The control terminal of the transistor M1 is coupled to the first terminal 602 of the error amplifier 600. The control terminal of the transistor M2 is coupled to the second terminal 604 of the error amplifier 600. The control terminal of the transistor M3 is coupled to the third terminal 606 of the error amplifier 600.

In some examples, the fifth terminal 610 of the error amplifier 600 is a power supply terminal and the sixth terminal 612 of the error amplifier 600 is a ground terminal. In some examples, the error amplifier 600 operates to: receive a current from the current source 620; receive VREF_BST at the first terminal 602; receive SS_RAMP at the second terminal 604; receive VFB at the third terminal 606; and provide VC at the fourth terminal 608 responsive to the current from the current source 620, VREF_BST, SS_RAMP, and VFB.

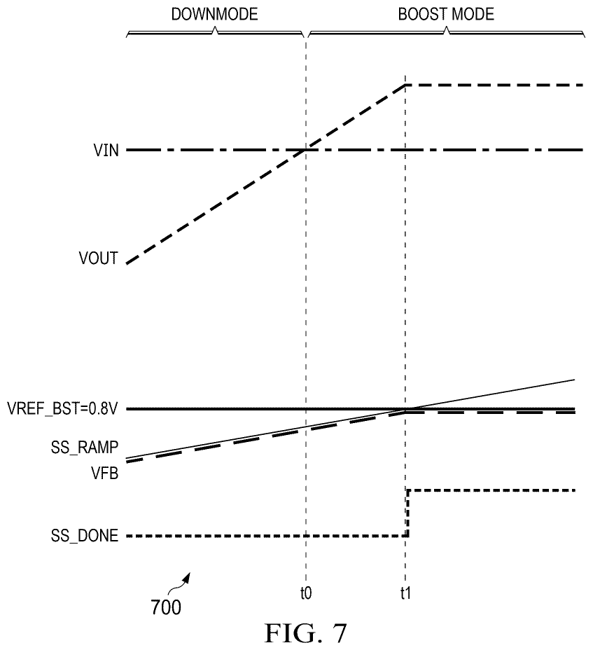

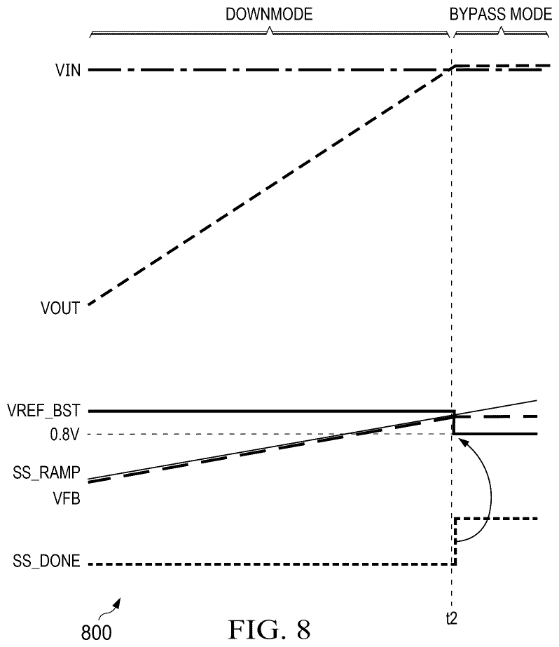

FIGS. 7 and 8 are timing diagrams 700 and 800 showing example waveforms. In the timing diagrams 700 and 800 of FIGS. 7 and 8, waveforms for VIN, VOUT, VREF_BST, SS_RAMP, VFB, and a soft-start done signal (SS_DONE) are represented for different soft-start scenarios. In the timing diagram 700 of FIG. 7, VIN is less than a target VOUT. As shown in the timing diagram 700, there is a downmode interval before time t0. During the downmode interval: VIN is constant and is greater than VOUT, which increases linearly; VREF_BST is set to a fixed value (e.g., 0.8V); and SS_RAMP and VFB increase linearly from zero. At time t0, a boost mode interval starts. During the boost mode interval, VOUT continues to increase linearly and is greater than VIN. When VFB increases up to VREF_BST at time t1, SS_DONE is asserted and VOUT reaches a target VOUT level.

In the timing diagram 800 of FIG. 8, VIN is greater than or equal to a target VOUT. As shown in the timing diagram 800, there is a downmode interval before time t2. During the downmode interval: VIN is constant and is greater than VOUT, which increases linearly; VREF_BST is set to a first value (e.g., VIN_DIV, which is greater than a second value such as 0.8V); and SS_RAMP and VFB increase linearly from zero. At time t2, a pass-through mode interval starts. During the pass-through mode interval: VOUT reaches a target VOUT level approximately equal to VIN; VREF_BST is reduced to a second value (e.g., 0.8V); and SS_DONE is asserted.

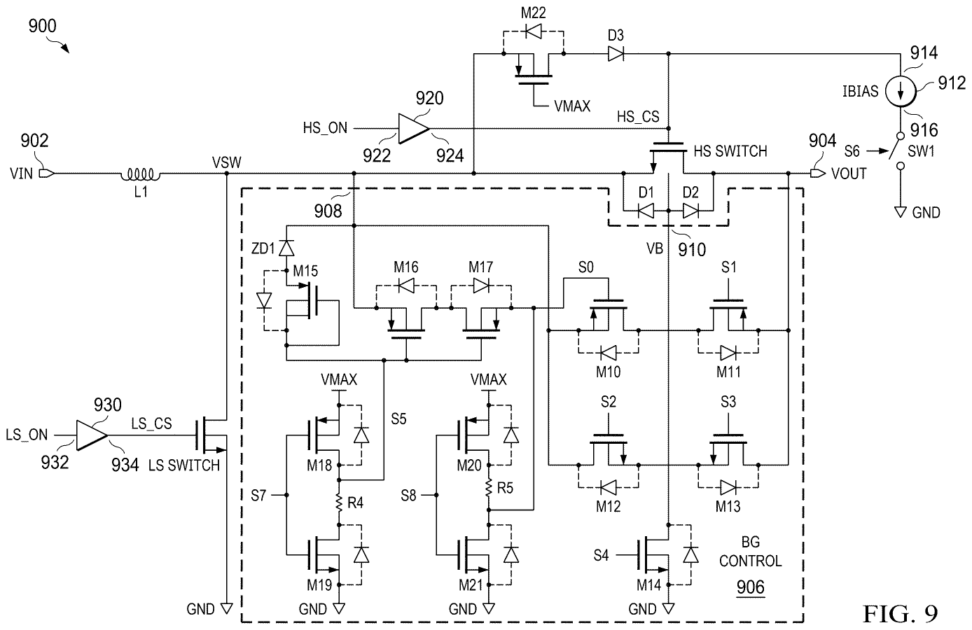

FIG. 9 is a diagram showing another example system 900. In the example of FIG. 9, the system 900 includes an input terminal 902, an output terminal 904, the inductor L1, HS driver circuitry 920, a HS switch, diodes D1 and D2, LS driver circuitry 930, a LS switch, a transistor M22, a diode D3, a bias current source 912, a switch SW1, and back-gate control circuitry 906. In the example of FIG. 9, the bypass switch or transistor and related bypass operations are omitted. In other examples, a bypass switch or transistor is included between the input terminal 902 and the output terminal 904.

In some examples, the HS driver circuitry 920 is part of the logic/driver circuitry 138 in FIG. 1, the driver circuitry 284 in FIG. 2, the HS and bypass driver circuitry 320 in FIG. 3, or the HS and isolation driver circuitry 403 in FIG. 4. The LS driver circuitry 930 is part of the logic/driver circuitry 138 in FIG. 1, the driver circuitry 284 in FIG. 2, the low-side driver circuitry 330 in FIG. 3, or the LS driver circuitry 410 in FIG. 4. The transistor M22, the diode D3, the bias current source 912, and the switch SW1 are part of a charge pump circuit (e.g., the charge pump circuitry 322 in FIG. 3). In some examples, the transistor M22 is a PFET. The back-gate control circuitry 906 is an example of the back-gate control circuitry 146 in FIG. 1, the back-gate control circuitry 276 in FIG. 2, the back-gate control circuitry 352 in FIG. 3, or the back-gate control circuitry 416 in FIG. 4. In some examples, the system 900 includes other components (e.g., control loop components, HS on/off control circuitry, LS on/off control circuitry) to generate HS_ON provided to the HS driver circuitry 920 and/or LS_ON provided to the LS driver circuitry 930.

The HS driver circuitry 920 has a first terminal 922 and a second terminal 924, the LS driver circuitry 930 has a first terminal 932 and a second terminal 934. The transistor M22 has a first terminal, a second terminal, and a control terminal. The diode D3 has a first (anode) terminal and a second (cathode) terminal. The bias current source 912 has a first terminal 914 and a second terminal 916. The switch SW1 has a first terminal, a second terminal, and a control terminal.

In the example of FIG. 9, the back-gate control circuitry 906 has a first terminal 908 and a second terminal 910. The back-gate control circuitry 906 includes a Zener diode ZD1, resistors R4 and R5, and transistors M10 to M21 in the arrangement shown. In some examples, the transistors M10, M11, M15 to M17, M18, M20 are PFETs, while the transistors M12 to M14, M19, and M21 are NFETs. The Zener diode ZD1 has a first (anode) terminal and a second (cathode) terminal. Each of the resistors R4 and R5 has a respective first terminal and a respective second terminal. Each of the transistors M10 to M21 has a respective first terminal, a respective second terminal, and a respective control terminal.

The input terminal 902 is coupled to the first terminal of the inductor L1. The second terminal of the inductor L1 is coupled to the first terminal of the HS switch, the first terminal of the LS switch, the first terminal 908 of the back-gate control circuitry 906, the first terminal of the transistor M22, and the second terminal of the diode D1. The second terminal of the LS switch is coupled to ground or a ground terminal. The control terminal of the LS switch is coupled to the second terminal 934 of the LS driver circuitry 930. The second terminal of the HS switch is coupled to the second terminal of the diode D2 and the output terminal 904. The back-gate terminal of the HS switch is coupled to the first terminals of the diodes D1 and D2, and the second terminal 910 of the back-gate control circuitry 906. The second terminal of the transistor M22 is coupled to the first terminal of the diode D3. The second terminal of the diode D3 is coupled to the control terminal of the HS switch, the second terminal 924 of the HS driver circuitry 920, and the first terminal 914 of the bias current source 912. The second terminal 916 of the bias current source 912 is coupled to the first terminal of the switch SW1. The second terminal of the switch SW1 is coupled to ground or a ground terminal.

The second terminal of the Zener diode ZD1 is coupled to the first terminal 908 of the back-gate control circuitry 906, the first terminals of the transistors M16, the second terminals of the transistor M10, and the first terminal of the transistor M12. The second terminal of the transistor M16 is coupled to the second terminal of the transistor M17. The second terminal of the transistor M15 is coupled to the control terminal of the transistor M15, the control terminals of the transistors M16 and M17, the second terminal of the transistor M18, and the first terminal of the resistor R4. The second terminal of the resistor R4 is coupled to the first terminal of the transistor M19. The second terminals of the transistors M19 and M21 are coupled to ground or a ground terminal. The control terminal of the transistor M18 and M19 receive a control signal S7. The second terminal of the transistor M17 is coupled to the control terminal of the transistor M10 (labeled as control signal S0), the second terminal of the resistor R5, and the first terminal of the transistor M21. The first terminal of the resistor R5 is coupled to the second terminal of the transistor M20. The first terminal of the transistor M20 is coupled to a maximum voltage (VMAX) terminal. The control terminals of the transistors M20 and M21 receive a control signal S8.

In some examples, the Zener diode ZD1 and the transistors M15 to M17 are a gate-drive circuit for the transistor M10. The gate-drive circuit for the transistor M10 may also include a first driver circuitry and a second driver circuitry. The first driver circuitry is formed by the transistors M18 and M19 and is controlled by the control signal S7. In some examples, the first driver circuitry provides the control signal S5 to the control terminals to the transistors M16 and M17 to adjust the control signal S0 at the control terminal of the transistor M10. The second driver circuitry is formed by the transistors M20 and M21 and is controlled by the control signal S8 to additionally or optionally adjust the control signal S0 at the control terminal of the transistor M10.

The first terminal of the transistor M10 is coupled to the first terminal of the transistor M11. The second terminal of the transistor M11 is coupled to the output terminal 904. The second terminal of the transistor M12 is coupled to the second terminal of the transistor M13. The first terminal of the transistor M13 is coupled to the output terminal 904. The control terminal of the transistor M11 receives a control signal S1. The control terminal of the transistor M12 receives a control signal S2. The control terminal of the transistor M13 receives a control signal S3. The first terminal of the transistor M14 is coupled to the back-gate terminal of the HS switch and the first terminals of the diodes D1 and D2. The second terminal of the transistor M14 is coupled to ground or a ground terminal. The control terminal of the transistor M14 receives a control signal S4.

In some examples, the back-gate control circuitry 906 performs cycle-by-cycle regulation of VB provided to the back-gate terminal of the HS switch. In some examples, during a downmode (VIN4 greater than VOUT4) with the LS switch on, the back-gate control circuitry 906 provides VB=0 to the back-gate of the HS switch. In some examples, during a downmode with the HS switch on, the back-gate control circuitry 906 provides VB=VOUT4 to the back-gate terminal of the HS switch. In some examples, during a boost mode (VOUT4 greater than VIN4) with the LS switch on, the back-gate control circuitry 906 provides VB=VSW (VSW=0 when the LS switch is on) to the back-gate terminal of the HS switch. In some examples, during a boost mode (VOUT4 greater than VIN4) with the HS switch on, the back-gate control circuitry 906 provides VB=VSW (VSW=VOUT when the HS switch is on) to the back-gate terminal of the HS switch.

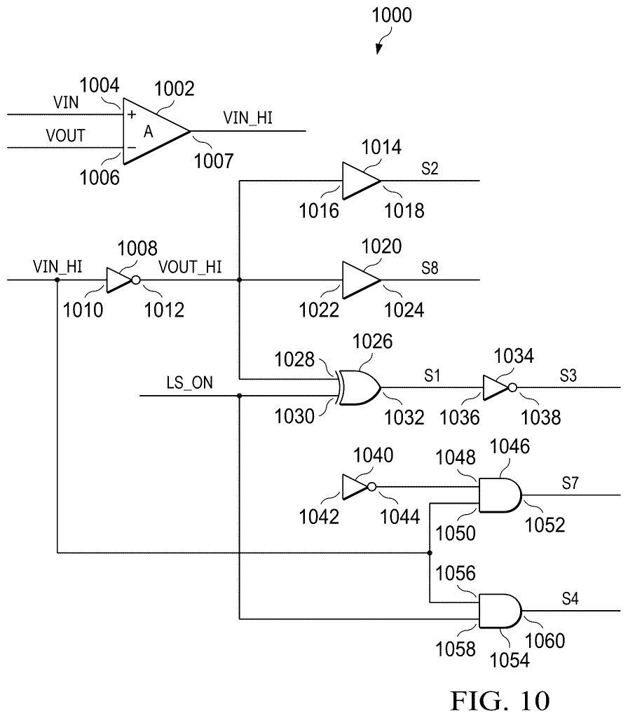

FIG. 10 is a schematic diagram showing example control logic 1000 for back-gate control circuitry. In the example of FIG. 10, the control logic 1000 provides the control signals S1, S2, S3, S4, S7, and S8 in FIG. 9. In the example of FIG. 10, the control logic 1000 includes comparator 1002, inverters 1008, 1034, and 1040, buffers 1014 and 1020, an XOR gate 1026, and AND gates 1046 and 1054 in the arrangement shown. The comparator 1002 has a first terminal 1004, a second terminal 1006, and a third terminal 1007. The inverter 1008 has a first terminal 1010 and a second terminal 1012. The buffer 1014 has a first terminal 1016 and a second terminal 1018. The buffer 1020 has a first terminal 1022 and a second terminal 1024. The inverter 1034 has a first terminal 1036 and a second terminal 1038. The inverter 1040 has a first terminal 1042 and a second terminal 1044. The XOR gate 1026 has a first terminal 1028, a second terminal 1030, and a third terminal 1032. The AND gate 1046 has a first terminal 1048, a second terminal 1050, and a third terminal 1052. The AND gate 1054 has a first terminal 1056, a second terminal 1058, and a third terminal 1060.

In the example of FIG. 10, the comparator 1002 operates to: receive VIN at the first terminal 1004; receive VOUT at the second terminal 1006; and provide VIN_HI at the third terminal 1007 responsive to VIN being greater than VOUT. The inverter 1008 operates to receive VIN_HI at the first terminal 1010 and provide VOUT_HI at the second terminal 1012 responsive to VIN_HI and inverter operations. The buffer 1014 operates to: receive VOUT_HI at the first terminal 1016; and provide the control signal S2 at the second terminal 1018. The buffer 1020 operates to: receive VOUT_HI at the first terminal 1022; and provide the control signal S8 at the second terminal 1024. The XOR gate 1026 operates to: receive VOUT_HI at the first terminal 1028; receive LS_ON at the second terminal 1030; and provide the control signal S1 at the third terminal 1032 receives to VOUT_HI and LS_ON. The inverter 1034 operates to: receive the control signal S1 at the first terminal 1036; and provide the control signal S3 (inverse of S1) at the second terminal 1038 responsive to the control signal S1 and inverter operations. The inverter 1040 operates to: receive LS_ON at the first terminal 1042; and provide the inverse of LS_ON at the second terminal 1044. The AND gate 1046 operates to receive the inverse of LS_ON at the first terminal 1048; receive VIN_HI at the second terminal 1050; and provide the control signal S7 at the third terminal 1052 responsive to the inverse of LS_ON and VIN_HI. The AND gate 1054 operates to: receive VIN_HI at the first terminal 1056; receive LS_ON at the second terminal 1058; and provide the control signal S4 at the third terminal 1060 responsive to VIN_HI and LS_ON.

In some examples, the control logic 1000 operates to: provide the control signal S1 to the control terminal of the transistor M11; provide the control signal S2 to the control terminal of the transistor M12; provide the control signal S3 to the control terminal of the transistor M13; provide the control signal S4 to the control terminal of the transistor M14; provide the control signal S7 to the control terminal of the transistors M18 and M19; and provide the control signal S8 to the control terminals of the transistor M20 and M21. With the control signals S1, S2, S3, S4, S7 and S8, the back-gate control circuitry 906 performs cycle-by-cycle regulation of VB provided to the back-gate terminal of the HS switch. In some examples, during a downmode (VIN4 greater than VOUT4) with the LS switch on, the control signals S1, S2, S3, S4, S7 and S8 result in VB=0 at the back-gate of the HS switch. In some examples, during a downmode with the HS switch on, the control signals S1, S2, S3, S4, S7 and S8 results in VB=VOUT4 at the back-gate terminal of the HS switch. In some examples, during a boost mode (VOUT4 greater than VIN4) with the LS switch on, the control signals S1, S2, S3, S4, S7 and S8 result in VB=VSW (VSW=0 when the LS switch is on) at the back-gate terminal of the HS switch. In some examples, during a boost mode (VOUT4 greater than VIN4) with the HS switch on, the control signals S1, S2, S3, S4, S7 and S8 result in VB=VSW (VSW=VOUT when the HS switch is on) at the back-gate terminal of the HS switch.

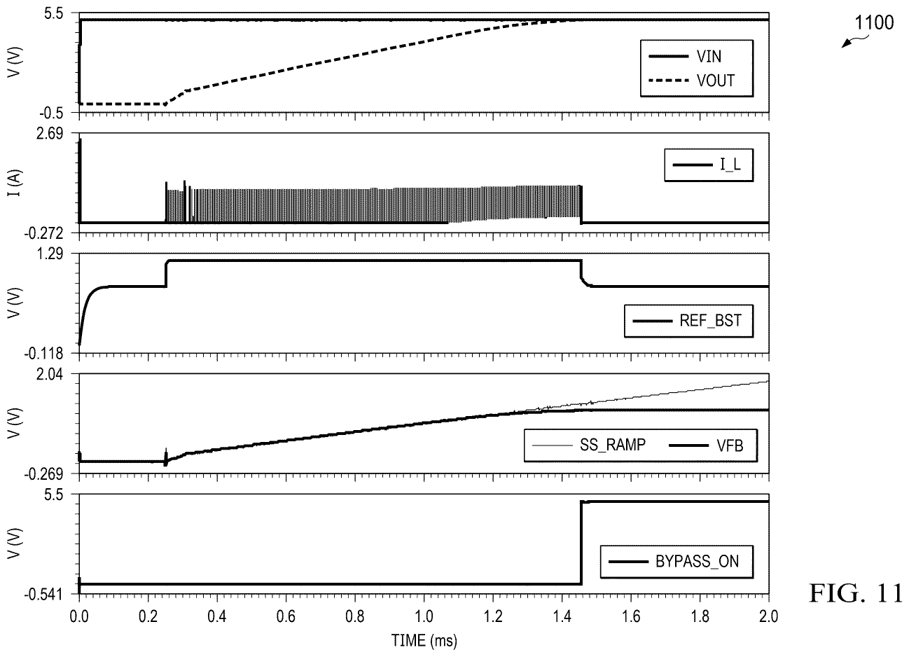

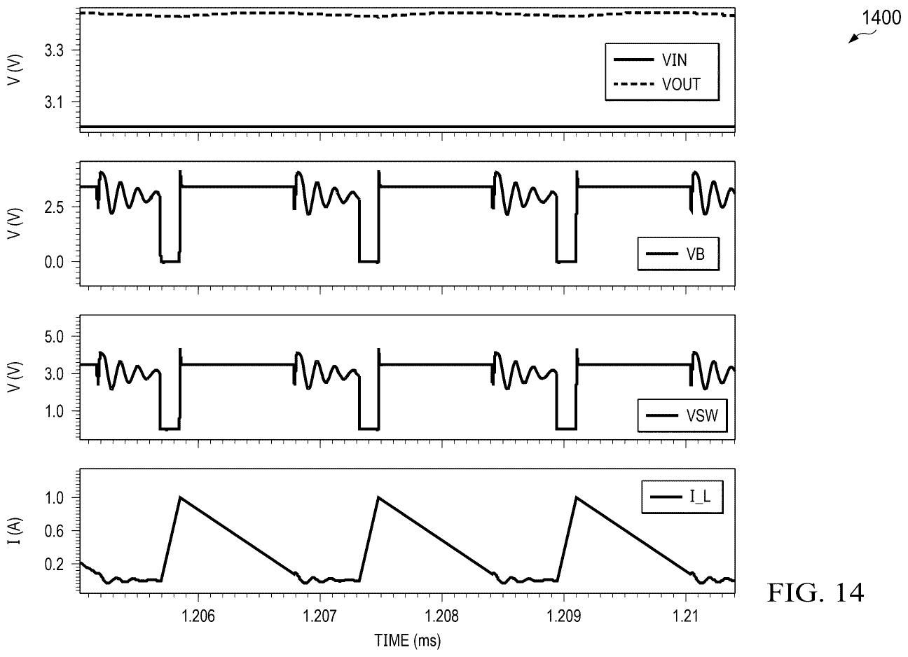

FIGS. 11 to 14 are timing diagrams 1100, 1200, 1300, and 1400 showing example waveforms. In the timing diagram 1100 of FIG. 11, waveforms for VIN, VOUT, inductor current (I_L), REF_BST, SS_RAMP, VFB, and a bypass on signal (BYPASS_ON) are represented for a soft start to pass-through mode scenario. Initially, at time 0.0 ms, VOUT is zero and is lower than VIN. From time 0.0 ms to about time 0.24 ms, REF_BST ramps up to a second value (e.g., 0.8V). At about time 0.24 ms, the related boost converter is enabled and REF_BST is set to the first value (e.g., VIN_DIV) by comparing VIN_DIV and VREF_TAR (e.g., 0.8V). Switching of the LS switch and the HS switch results in: I_L ramping up and down; and VOUT increasing (followed with the slope of SS_RAMP). While VOUT increases until VOUT reaches VIN at about 1.44 ms, BYPASS_ON is asserted and a pass-through mode begins. In some examples, during the pass-through mode: both the HS switch and the LS switch are off; the bypass transistor (see e.g., FIG. 3) in on; I_L goes to zero; and VOUT is approximately equal to VIN, and REF_BST is set to the second value (e.g., 0.8V).

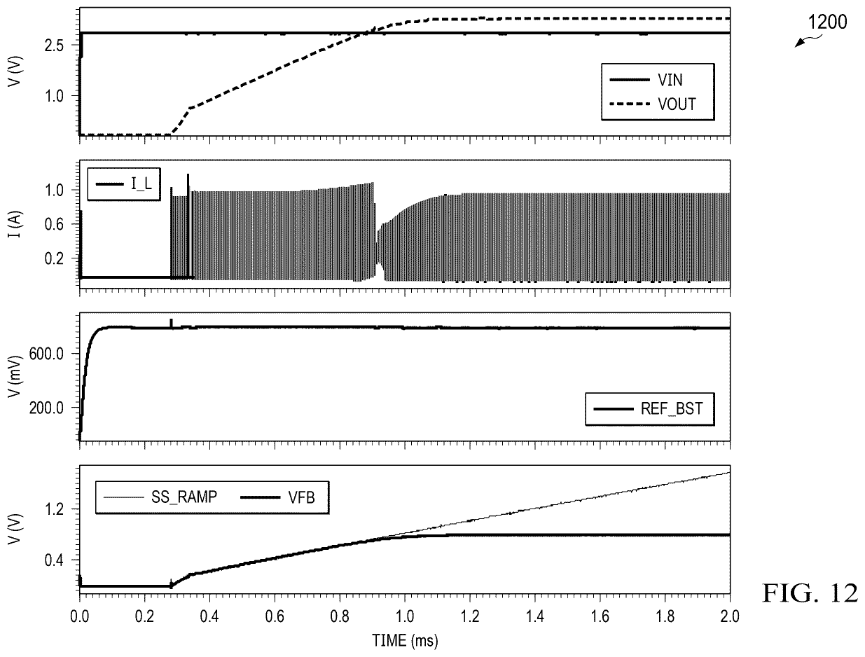

In the timing diagram 1200 of FIG. 12, waveforms for VIN, VOUT, I_L, REF_BST, SS_RAMP, and VFB are represented for a soft start to boost mode scenario. Initially, at time 0.0 ms, VOUT is zero and is lower than VIN. From time 0.0 ms to about time 0.28 ms, REF_BST ramps up to a second value (e.g., 0.8V). At about time 0.28 ms, boost converter is enabled and REF_BST is set to the second value by comparing VIN_DIV and VREF_TAR. Switching of the LS switch and the HS switch results in: I_L ramping up and down; and VOUT increasing. While VOUT increases and is still below VIN, the boost converter operates in downmode and VFB is less than REF_BST. At about 0.9 ms, VOUT exceeds VIN, and the boost mode starts. During the boost mode: I_L continues to ramp up and down; VOUT is maintained at a target VOUT above VIN.

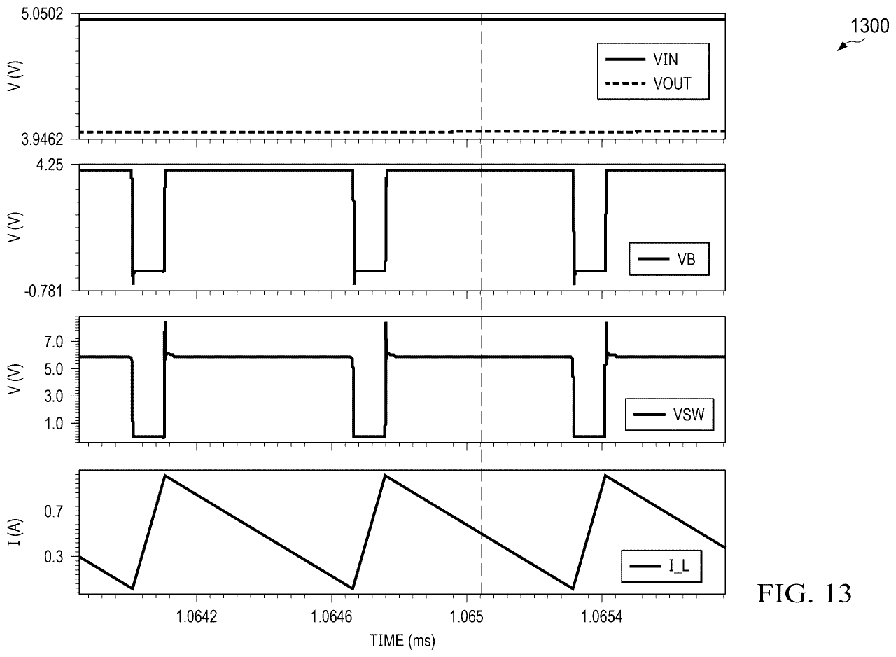

In the timing diagram 1300 of FIG. 13, waveforms for VIN, VOUT, VB, VSW, and I_L are represented for a downmode (i.e., VIN greater than VOUT) scenario. When I_L ramps up, VSW and VB go to 0. When I_L ramps down, VSW is approximately equal to VIN+VGS and VB is set to VOUT.

In the timing diagram 1400 of FIG. 13, waveforms for VIN, VOUT, VB, VSW, and I_L are represented for a boost mode (i.e., VIN less than VOUT) scenario. When I_L ramps up, VSW and VB go to 0. When I_L ramps down, VSW is approximately equal to VOUT and VB is set to VSW.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component and/or a conductor.

A circuit or device described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field-effect transistor (“FET”) such as an NFET or a PFET, a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control terminal and its first and second terminals. In the context of a FET, the control terminal is the gate, and the first and second terminals are the drain and source. In the context of a BJT, the control terminal is the base, and the first and second terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. A circuit comprising:
a first transistor having a first terminal, a second terminal, and a control terminal;
a second transistor having a first terminal, a second terminal, and a control terminal;
a controller having a first terminal, a second terminal, a third terminal, and a fourth terminal, the third terminal of the controller coupled to the control terminal of the first transistor, the fourth terminal of the controller coupled to the control terminal of the second transistor, the controller including an error amplifier and reference voltage control circuitry, and the reference voltage control circuitry configurable to:
provide a first reference voltage to the error amplifier responsive to an input voltage being less than a target output voltage; and
provide a second reference voltage to the error amplifier if the input voltage is greater than or equal to the target output voltage.

2. The circuit of claim 1, wherein the first transistor has a back-gate terminal, the controller includes back-gate control circuitry coupled to the back-gate terminal, and the back-gate control circuitry is configurable to:
provide a first voltage to the back-gate terminal responsive to a first condition;
provide second voltage to the back-gate terminal responsive to a second condition; and
provide a third voltage to the back-gate terminal responsive to a third condition.

3. The circuit of claim 2, wherein the first condition includes a boost converter input voltage greater than a boost converter output voltage and the second transistor turned on, the second condition includes the boost converter input voltage greater than the boost converter output voltage and the second transistor turned off, and the third condition includes the boost converter input voltage not greater than the boost converter output voltage.

4. The circuit of claim 3, wherein the first voltage is a ground voltage, the second voltage is the boost converter output voltage, and the third voltage is an inductor voltage.

5. The circuit of claim 1, wherein the second reference voltage is greater than the first reference voltage.

6. The circuit of claim 5, wherein the second reference voltage is equal to the input voltage.

7. The circuit of claim 1, wherein the first transistor is an n-channel field-effect transistor (NFET).

8. A circuit comprising:
a switch having a first terminal, a second terminal, and a control terminal, the switch being an n-channel field-effect transistor (NFET);
an error amplifier having a first terminal, a second terminal, and a third terminal, the second terminal of the error amplifier coupled to the second terminal of the switch; and
reference voltage control circuitry having a first terminal, a second terminal, and a third terminal, the third terminal of the reference voltage control circuitry coupled to the first terminal of the error amplifier.

9. The circuit of claim 8, wherein the reference voltage control circuitry includes:
a first resistor having a first terminal and a second terminal, the first terminal of the first resistor coupled to the first terminal of the reference voltage control circuitry;
a second resistor having a first terminal and a second terminal, the first terminal of the second resistor coupled to the second terminal of the first resistor; and
a comparator having a first terminal, a second terminal, and a third terminal, the first terminal of the comparator coupled to the second terminal of the first resistor, and the second terminal of the comparator coupled to the second terminal of the reference voltage control circuitry.

10. The circuit of claim 9, wherein the reference voltage control circuitry includes a multiplexer having a first terminal, a second terminal, a third terminal, and a fourth terminal, the first terminal of the multiplexer coupled to the second terminal of the first resistor, the second terminal of the multiplexer coupled to the second terminal of the reference voltage control circuitry, the third terminal of the multiplexer coupled to the third terminal of the comparator, and the fourth terminal of the multiplexer coupled to the third terminal of the reference voltage control circuitry.

11. The circuit of claim 8, wherein the switch includes a back-gate terminal, and the circuit further comprises back-gate control circuitry including:
a first transistor having a first terminal, a second terminal, and a control terminal, the first terminal of the first transistor coupled to the first terminal of the switch, and the second terminal of the first transistor coupled to the back-gate terminal;
a second transistor having a first terminal, a second terminal, and a control terminal, the first terminal of the second transistor coupled to the back-gate terminal, and the second terminal of the second transistor coupled to the second terminal of the switch;
a third transistor having a first terminal, a second terminal, and a control terminal, the first terminal of the third transistor coupled to the first terminal of the switch, and the second terminal of the third transistor coupled to the back-gate terminal;
a fourth transistor having a first terminal, a second terminal, and a control terminal, the first terminal of the fourth transistor coupled to the back-gate terminal, and the second terminal of the fourth transistor coupled to the second terminal of the switch; and
a fifth transistor having a first terminal, a second terminal, and a control terminal, the first terminal of the fifth transistor coupled to the back-gate terminal.

12. The circuit of claim 11, wherein the back-gate control circuitry includes a gate drive circuit for the first transistor, the gate drive circuit including:
a Zener diode having an anode terminal and a cathode terminal, the cathode terminal coupled to the first terminal of the back-gate control circuitry;
a sixth transistor having a first terminal, a second terminal, and a control terminal, the first terminal of the sixth transistor coupled to the anode terminal of the Zener diode;
a seventh transistor having a first terminal, a second terminal, and a control terminal, the first terminal of the seventh transistor coupled to the first terminal of the back-gate control circuitry; and
an eighth transistor having a first terminal, a second terminal, and a control terminal, the first terminal of the eighth transistor coupled to the second terminal of the seventh transistor, and the second terminal of the eighth transistor coupled to the second terminal of the gate control circuitry.

13. The circuit of claim 12, wherein the back-gate control circuitry includes:
first driver circuitry having a first terminal, a second terminal, and a third terminal, the first terminal of the first driver circuitry coupled to the switch, and the third terminal of the first driver circuitry coupled to the second terminal of the sixth transistor, the control terminal of the seventh transistor, and the control terminal of the eighth transistor; and
second driver circuitry having a first terminal, a second terminal, and a third terminal, the first terminal of the second driver circuitry coupled to the switch, and the third terminal of the second driver circuitry coupled to the second terminal of the gate control circuitry.

14. The circuit of claim 13, wherein the switch is a first switch and the circuit further comprises:
a second switch having a first terminal, a second terminal, and a control terminal; and
control logic having a first terminal, a second terminal, a third terminal, a fourth terminal, a fifth terminal, a sixth terminal, a seventh terminal, an eighth terminal, and a ninth terminal, the second terminal of the control logic coupled to the second terminal of the first switch, the third terminal of the control logic coupled to the control terminal of the second switch, the fourth terminal of the control logic coupled to the control terminal of the second transistor, the fifth terminal of the control logic coupled to the control terminal of the third transistor, the sixth terminal of the control logic coupled to the control terminal of the fourth transistor, the seventh terminal of the control logic coupled to the control terminal of the fifth transistor, the eighth terminal of the control logic coupled to the second terminal of the first driver circuitry, and the ninth terminal of the second terminal of the second driver circuitry.

15. A switch controller comprising:
an error amplifier; and
reference voltage control circuitry coupled to the error amplifier and configurable to:
provide a first reference voltage to the error amplifier responsive to an input voltage being less than a target output voltage; and
provide a second reference voltage to the error amplifier if the input voltage is greater than or equal to the target output voltage.

16. The switch controller of claim 15, further comprising back-gate control circuitry configurable to:
provide a first voltage responsive to a first condition;
provide second voltage responsive to a second condition; and
provide a third voltage responsive to a third condition.

17. The switch controller of claim 16, wherein the first condition includes a boost converter input voltage greater than a boost converter output voltage and a switch control signal being asserted, the second condition includes the boost converter input voltage greater than the boost converter output voltage and the switch control signal being de-asserted, and the third condition includes the boost converter input voltage not greater than the boost converter output voltage.

18. The switch controller of claim 17, wherein first voltage is a ground voltage, the second voltage is the boost converter output voltage, and the third voltage is a boost converter switch node voltage.

19. The switch controller of claim 15, wherein the second reference voltage is greater than the first reference voltage.

20. The switch controller of claim 16, wherein the reference voltage control circuitry includes a voltage divider, a comparator, and a multiplexer, and the back-gate control circuitry include a first transistor, a second transistor, a third transistor, a fourth transistor, a fifth transistor, gate control circuitry for the first transistor, the gate control circuitry having an input terminal and an output terminal, the output terminal of the gate control circuitry coupled to a control terminal of the first transistor, and control logic having respective output terminals coupled to the input terminal of the gate control circuitry and control terminals of the second transistor, the third transistor, the fourth transistor, and the fifth transistor.
